(19) United States
(12) Patent Application Publication
(10) Pub. No.: US 2008/0006126 A1
(43) Pub. Date: Jan. 10, 2008

(54) Hexagonal bolt head and hexagonal recess of socket

(76) Inventor: Chih-Ching Hsieh, Taichung City (TW)

Correspondence Address: PHILLIP LIU, 6980, WHITEOAK DR., RICHMOND, BC, V7EAZ9, CA

(21) Appl. No.: 11/480,953

(22) Filed: Jul. 6, 2006

(51) Int. Cl. B25B 13/06; F16B 23/00; F16B 35/06

(52) U.S. Cl. 81/121.1; 411/402

(57) ABSTRACT

An easy engagement periphery of hexagonal object, such as a bolt head and a recess of a socket includes two first curved bumps extending from three alternative sides of the hexagonal bolt head, and each corner of the hexagonal bolt head is a second curved bump. By the first and second curved bumps, the first curved bumps and the two second curved bumps of each to the three alternative sides of the bolt head form at least four contact portions with the alternative three sides of the tool that drives the bolt head.

### FIELD OF THE INVENTION

The present invention relates to a hexagonal head of a bolt and a hexagonal recess of a socket, and the bolt head and recess provide more contact portions when cooperated with a socket and a hexagonal object.

### BACKGROUND OF THE INVENTION

A conventional bolt head is generally a hexagonal head which includes six sides and six peaks. The head is designed such that a wrench or a socket can be securely engaged therewith so as to apply torque to the bolt. Generally, when the bolt head is cooperated with a socket, the socket has a hexagonal recess so as to match with the hexagonal head. In order to ensure that the socket can be easily mounted to the bolt heads with manufacturing tolerances, the size of the hexagonal recess is slightly larger than the bolt head, so that only parts of the sides and the peaks of the bolt head are actually in contact with the hexagonal recess of the socket. In other words, when a torque is applied to the bolt head, the force is concentrated on the contact area or points and easily worn out the bolt head. Once the bolt head is worn out or the peals are rounded, it is difficult to be well cooperated with the socket.

U.S. Pat. No. 5,476,024 discloses a socket module that has tiny and sharp teeth extending from three alternative sides of the six sides of the recess in a socket, and protrusions extending from the other three alternative sides. Three sides of a hexagonal bolt head “bit” by the teeth and three sides are in contact with the protrusions when the socket is mounted on the hexagonal bolt head. The teeth are tiny and sharp, they tend to be worn out after frequent use if the material of the teeth is softer than the material of the bolt head. On the other hand, if the material of the bolt head is softer than the material of the socket, the hexagonal head of the bolt could be rounded out quickly.

The present invention intends to provide a bolt head and a socket wherein three alternative sides of the hexagonal sides include two first curved bumps and each corner is shaped to be a second curved bump. By the arrangement, the bolt head of the present invention can be firmly clamped by a conventional socket, and the socket of the present invention is able to clamp the conventional bolt head without worry of slippery.

### SUMMARY OF THE INVENTION

The present invention relates to a bolt that comprises a hexagonal head and a shank extending from an underside of the head. Three alternative sides of the hexagonal head have two first curved bumps extending therefrom and each corner of the hexagonal bolt head is a second curved bump. The present invention can be used for the six sides of a hexagonal recess of a socket.

The present invention is applied to a hexagonal recess of a socket so as to be firmly cooperated with a conventional hexagonal bolt head.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show a bolt with a hexagonal head of the present invention;

FIG. 2 shows that a conventional socket is to be engaged with the bolt head of the present invention;

FIG. 3 is a cross sectional view to show that the bolt head is engaged with a hexagonal recess of the conventional socket;

FIG. 4 is a perspective view to show a socket with a hexagonal recess of the present invention;

FIG. 5 shows a bottom view of the hexagonal recess of the socket of the present invention;

FIG. 6 is a cross sectional view to show the socket of the present invention;

FIG. 7 shows that the socket of the present invention is to be engaged with a conventional bolt head;

FIG. 8 is a cross sectional view to show that the conventional bolt head is engaged with the hexagonal recess of the socket of the present invention;

FIG. 9 shows that the socket of the present invention is to be engaged with the bolt head of the present invention, and

FIG. 10 is a cross sectional view to show that the bolt head of the present invention is engaged with the hexagonal recess of the socket of the present invention.

### DETAILED DESCRIPTION OF THE PREFERRED EMBODIMENT

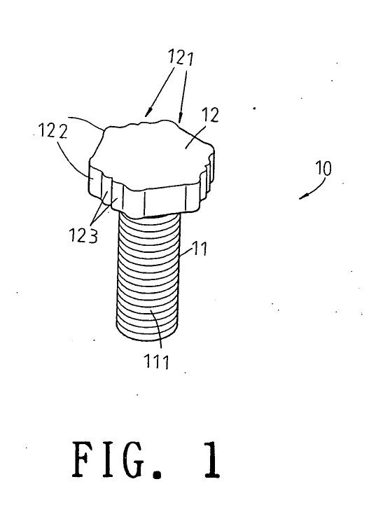

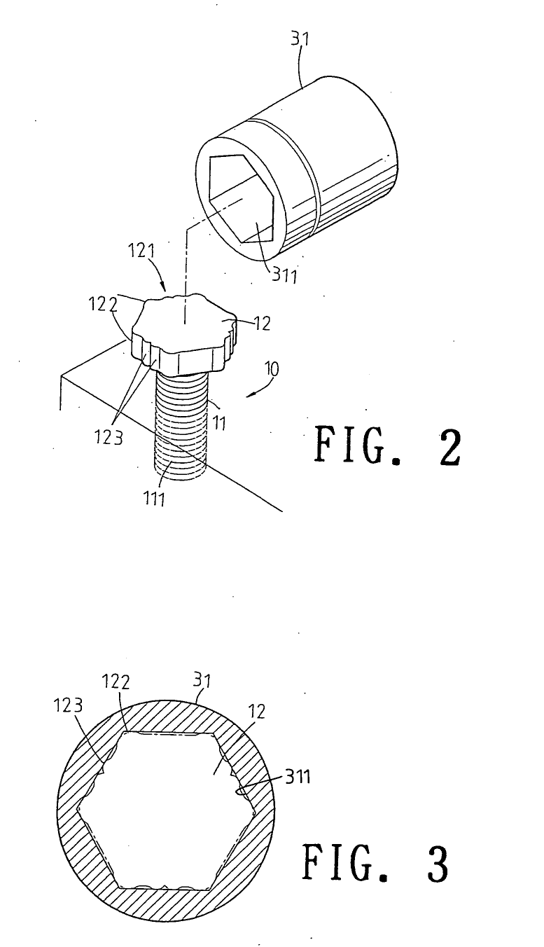

Referring to FIGS. 1 to 3, the bolt 10 of the present invention comprises a hexagonal head 12 and a shank 11 which extends from an underside of the head 12. Threads 111 are defined in an outer periphery of the shank 11. The hexagonal head 12 includes six sides 121 wherein three alternative sides 121 of the hexagonal head 12 have two first curved bumps 123 extending from a mediate portion thereof and each corner of the hexagonal head 12 is a second curved bump 122. Each of the first curved bumps 123 is smaller than each of the second curved bumps 122.

When a conventional socket 31 is used to drive the bolt 10, the bolt head 12 is engaged with the hexagonal recess 311 of the conventional socket 31. The six second curved bumps 122 are engaged with the six corners of the recess 311 of the conventional socket 31, and the first curved bumps 123 of the three alternative sides 121 are in contact with the side of the recess 311 of the conventional socket 31 as shown in FIG. 3. Therefore, there are at least four contact portions between each side of the hexagonal recess 311, the at least four contact portions allow the conventional socket 31 to effectively drive the bolt head 12. Besides, the special arrangement of the bolt head 12 may prevent the bolt head 12 from being worn out and/or damaged.

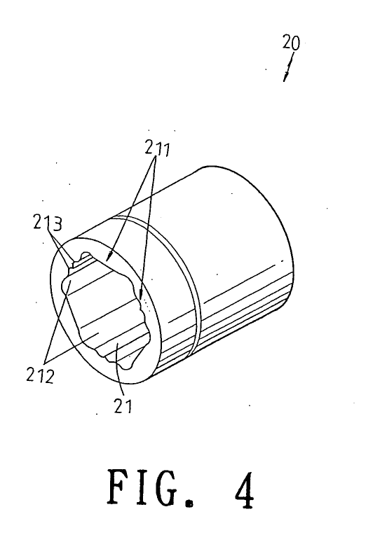

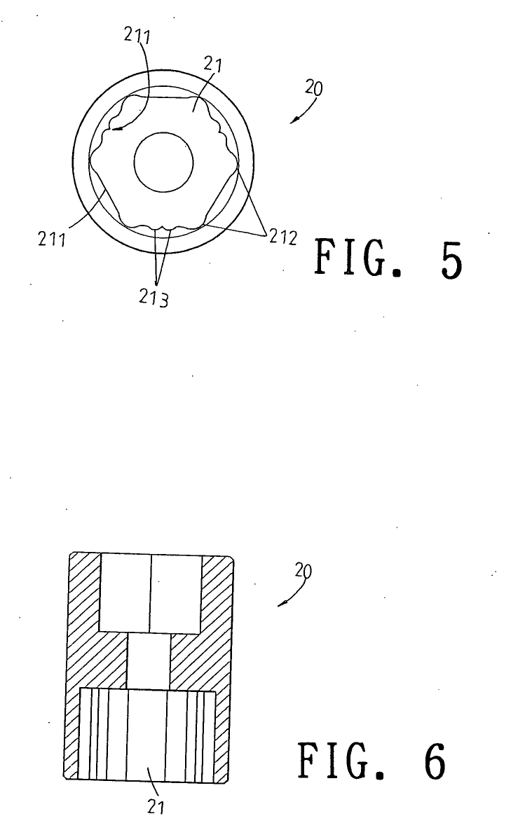

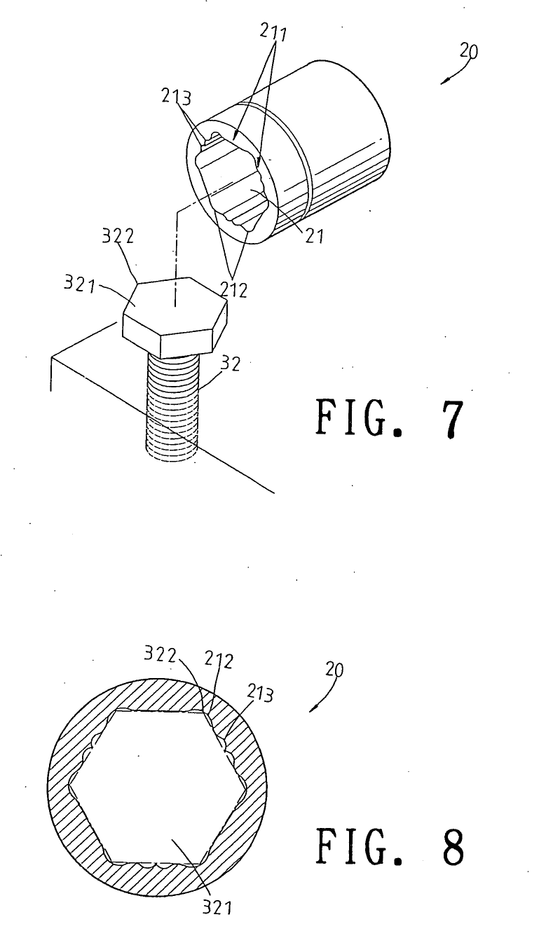

As shown in FIGS. 4 to 8, the arrangement can also be used to the recess of a socket 20 which is a cylindrical body with a hexagonal recess 21 defined in an end thereof Three alternative sides 211 of the hexagonal recess 21 have two first curved recesses 213 defined therein and each corner of the hexagonal recess 21 is a second curved recess 212. The first curved recesses 213 are located at a mediate portion of each of the alternative three sides 211 of the hexagonal recess 21, and each of the first curved recesses 123 is smaller than each of the second curved recesses 212.

When using the socket 20 of the present invention to mount a conventional hexagonal bolt head 321 of a bolt 32, the six corners of the conventional bolt head 321 are engaged with the six second curved recesses 212 of the socket 20 of the present invention, and the first curved protrusions 213 of the recess 21 of the socket 20 are in contact with the thee sides of the conventional hexagonal bolt head 321. The other three sides of the conventional hexagonal bolt head 321 are matched with the other three alternative sides 211 of the recess 21 of the present invention.

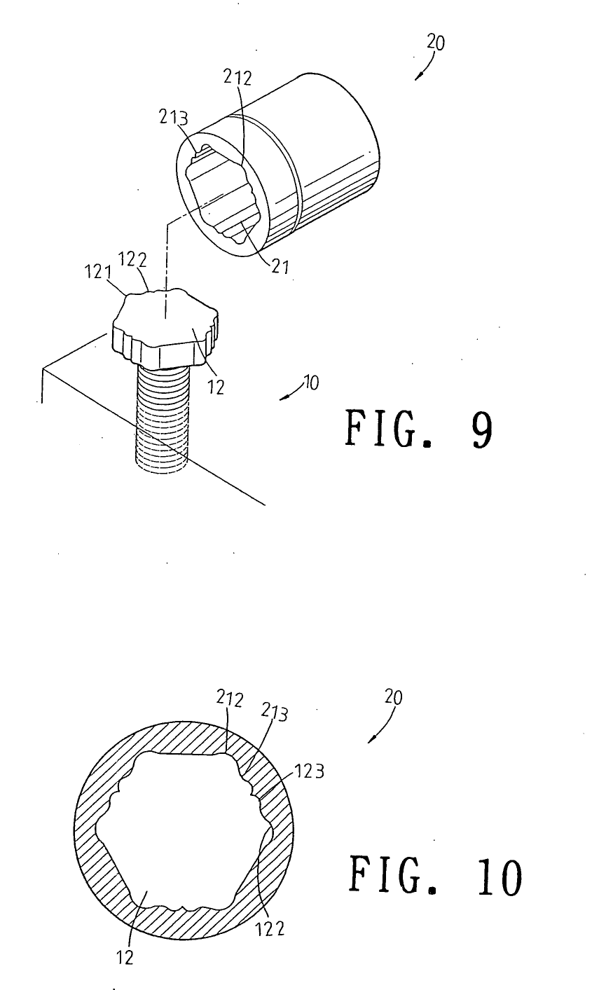

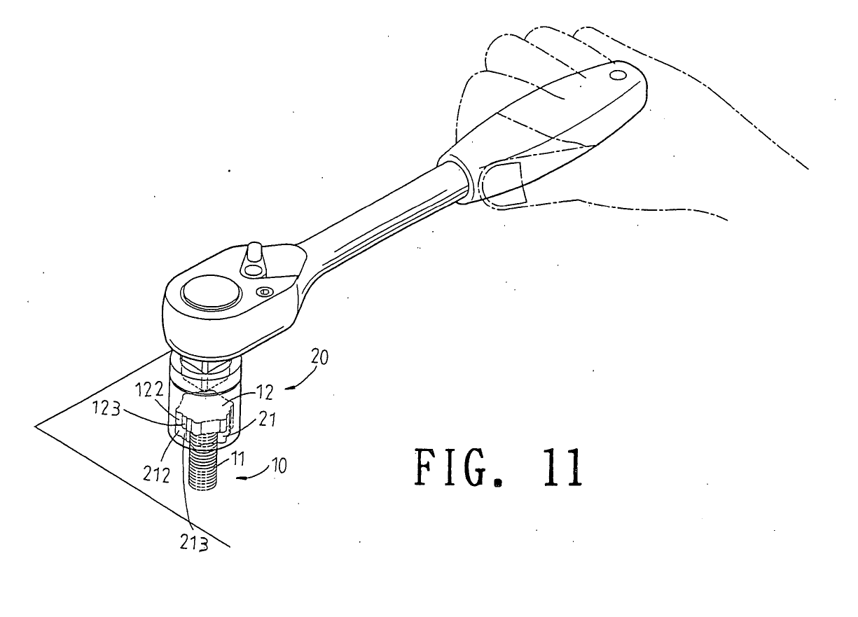

FIGS. 9 to 11 show that the bolt 10 and the socket 20 of the present invention can also be cooperated with each other. The first curved bumps 123 of the bolt head 12 are engaged with the first curved recesses 213 of the socket 20, the second curved bumps 121 of the bolt head 12 are engaged with the second curved recesses 212.

While we have shown and described the embodiment in accordance with the present invention, it should be clear to those skilled in the art that further embodiments may be made without departing from the scope of the present invention.

1. A bolt (10) comprising:
a hexagonal head (12) and a shank (11) which extends from an underside of the head (12) and threads (111) defined in the shank (11), three alternative sides (121) of the hexagonal head (12) having two first curved bumps (123) extending therefrom and each corner of the hexagonal head (12) being a second curved bump (122) so that each of the three alternative sides (121) including the first and second curved bumps (123, 122) provides at least four contact points with a socket, the first curved bumps (123) located at a mediate portion of the side of the hexagonal head (12).

2. (canceled)

3. The bolt as claimed in claim 1, wherein each of the first curved bumps (123) is smaller than each of the second curved bumps (122).

4. (canceled)

5. (canceled)

6. (canceled)
